(19) United States
(12) Patent Application Publication
(10) Pub. No.: US 2009/0104390 A1
(43) Pub. Date: Apr. 23, 2009

(54) LAMINATED STEEL SHEET FOR TWO-PIECE CAN, METHOD FOR MANUFACTURING TWO-PIECE CAN, AND TWO-PIECE LAMINATED CAN

(75) Inventors: Hiroshi Kubo, Hiroshima (JP); Katsumi Kojima, Hiroshima (JP); Yuka Nishihara, Chiba (JP); Yoshihiko Yasue, Hiroshima (JP); Hiroki Iwasa, Hiroshima (JP)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: JFE Steel Corporation, Tokyo (JP)

(21) Appl. No.: 11/990,371

(22) PCT Filed: Aug. 10, 2006
(86) PCT No.: PCT/JP2006/316122

§ 371 Date: Feb. 12, 2008

(30) Foreign Application Priority Data
Aug. 12, 2005 (JP) 2005-234562

(51) Int. Cl. B32B 15/08; B32B 1/02; B21D 51/26

(52) U.S. Cl. 428/35.7; 428/458; 413/1; 72/342.1; 72/379.4

(57) ABSTRACT

The laminated steel sheet for two-piece can satisfies the relation of the height h of the final formed body, the maximum radius r thereof, the minimum radius d thereof, with the radius R of circular disk, before forming, having the same weight to that of the final formed body, as [0.1≦d/R≦0.25] and [1.5≦h/(R−r)≦4]. The laminated steel sheet has a polyester resin layer prepared by polycondensation of a dicarboxylic acid component and a diol component. The dicarboxylic component has terephthalic acid as the main ingredient, and the diol component has ethylene glycol and/or butylene glycol as the main ingredient. The quantity of copolymerizing ingredients is ranging from 8 to 16% by mole. The plane orientation factor of the resin is 0.06 or less.

### RELATED APPLICATION

This is a §371 of International Application No. PCT/JP2006/316122, with an international filing date of Aug. 10, 2006 (WO 2007/020951 A1, published Feb. 22, 2007), which is based on Japanese Patent Application No. 2005-234562, filed Aug. 12, 2005.

### TECHNICAL FIELD

This disclosure relates to laminated steel sheets suitable for manufacturing two-piece cans of high strain level, such as aerosol cans, methods for manufacturing two-piece cans, and two-piece laminated cans of high strain level.

### BACKGROUND

Metal containers of aerosol are largely grouped into two-piece cans and three-piece cans. The two-piece can is a can structured by two segments, namely the can body integrated with the can bottom and the can end. The three-piece can is a can structured by three segments, namely the can body, the top end, and the bottom end. The two-piece can has no seam (welded part) so that it gives beautiful appearance. However, the two-piece can generally requires high strain. Since the three-piece can has the seam, it is inferior in appearance to the two-piece can. The three-piece can, however, generally requires low strain. Therefore, the two-piece can is widely used for small capacity and high grade goods in the market, and the three-piece can is generally used for large capacity and low price goods.

The metal base material for an aerosol two-piece can usually adopts expensive and thick aluminum sheet, and rarely uses steel sheet base material such as inexpensive and thin sheet, including tinplate and tin-free steel. The reason is that, since the aerosol two-piece can requires high strain, drawing and DI working are difficult to apply, while aluminum allows applying impact-molding applicable to soft metallic materials. In this situation, if the steel sheet base material such as tinplate and tin-free steel which are inexpensive and high strength even with a thin sheet thickness is applicable, the industrial significance becomes remarkably high.

Although there were many proposals of drawing and DI working methods of laminated steel sheet, there is no proposal of the method for manufacturing cans such as an aerosol two-piece can of large drawing ratio and high elongation in the can height direction.

For example, Examined Japanese Patent Publication No. 7-106394, Japanese Patent No.2526725 and Japanese Patent Laid-Open No.2004-148324 disclose the working methods for drawing and drawing-ironing for resin-laminated metal sheet. The strain level described in Examined Japanese Patent Publication No.7-106394, Japanese Patent No.2526725 and Japanese Patent Laid-Open No.2004-148324 (drawing ratio in Examined Japanese Patent Publication No. 7-106394, Japanese Patent No. 2526725 and Japanese Patent Laid-Open No. 2004-148324), is lower than the range specified. This is because Examined Japanese Patent Publication No. 7-106394, Japanese Patent No.2526725 and Japanese Patent Laid-Open No. 2004-148324 place the target to beverage cans, food cans, and the like, and beverage cans and food cans are the cans requiring lower strain than the range of strain level specified.

Japanese Patent No. 2526725 and Japanese Patent Laid-Open No. 2004-148324 describe that, aiming to gain the prevention of delamination of resin layer and the barrier property after working, a heat treatment is applied during working and/or at an interim stage of working, or at the final stage. Japanese Patent No. 2526725 uses an orientating thermoplastic resin, and Japanese Patent Laid-Open No. 2004-148324 uses a compound of saturated polyester and ionomer.

Examined Japanese Patent Publication Nos. 59-35344 and 61-22626 describes methods of relaxing internal stress mainly by applying heat treatment at or above the melting point of the resin, and describe the application of heat treatment at a stage after the can-forming. The strain level of the can is low suggested by the detail description and by the description of examples.

Japanese Patent No. 2526725 proposes heat treatment in order to relax the internal stress and to enhance the orientation crystallization, which method has become common to beverage can and the like. Although Japanese Patent No. 2526725 does not give detail description, the temperature of heat treatment is presumably at or below the melting point since the orientation crystallization is accelerated at or below the melting point. The description and the examples of Japanese Patent No. 2526725 show that the strain level is lower than the strain level specified.

Conventional technologies did not provide methods for manufacturing cans such as aerosol two-piece cans using laminated steel sheet applying high strain. Thus, we fabricated two-piece cans using laminated steel sheet applying high strain of the steps of drawing-ironing of the laminated steel sheet to form into a shape of a cylinder integrated with a bottom, followed by diametral reduction in the vicinity of opening of the cylinder, and found the occurrence of problems characteristic to high strain, specifically the problem of delamination and fracture of resin layer. Our efforts revealed the effectiveness of the heat treatment in qualitative view. However, sole heat treatment was not sufficient, and the delamination of resin layer unavoidably appeared in a zone of high strain. As a result, simple application of the related art did not solve the problem of delamination of the resin layer. In addition, there appeared a problem of deterioration of formability of the resin layer during the forming after the heat treatment.

It could therefore be advantageous to provide a laminated steel sheet for a two-piece can which prevents delamination and fracture of the laminate resin layer even when a can of high strain level such as an aerosol two-piece can is manufactured, and to provide a method for manufacturing the two-piece can. It could also be advantageous to provide a can of high strain level, such as an aerosol two-piece can, using the laminated steel sheet.

### SUMMARY

An important characteristic required for the resin layer during the high strain forming is the difficulty in orientation. Resin usually orients in the can height direction owing to the compressive deformation in the circumferential direction and to the elongational deformation in the can-height direction. Our investigations revealed that polyethylene terephthalate copolymers or polybutylene terephthalate copolymers are promising ones for above high strain forming. Our investigations also found that, for polyethylene terephthalate copolymers or polybutylene terephthalate copolymers, a smaller quantity of copolymerization component causes generation of more cracks (fractures) in parallel with each other in the can-height direction. We also found that orientation similarly progressed even for the case of applying heat treatment to the can after working. Then, we found that increasing the quantity of the copolymerization component of resin solves the above problems.

We thus provide the following:

(1) A laminated steel sheet used for producing a two-piece can, which satisfies the following relations:

0.1≦d/R≦0.25

1.5≦h/(R−r)≦4

wherein

h is a height of a final formed body,

r is a maximum radius of the final formed body,

d is a minimum radius of the final formed body (including the case that r and d are equal),

R is a radius of a circular disk, before forming, having the same weight to that of the final formed body,

wherein

at least one face of the steel sheet has a polyester resin layer,

the polyester resin is obtained by polycondensation of a dicarboxylic acid component and a diol component,

the dicarboxylic component contains terephthalic acid as the main ingredient and a copolymerizing ingredient,

the diol component contains ethylene glycol and/or butylene glycol as the main ingredient and a copolymerizing ingredient, the sum of the copolymerizing ingredient in the dicarboxylic acid and the copolymerizing ingredient in the diol component is ranging from 8 to 16% by mole in the polyester resin, and

the polyester resin laminate layer has 0.06 or less of plane orientation factor.

(2) The laminated steel sheet for a two-piece can according to (1), wherein
the dicarboxylic acid component contains an isophthalic acid ingredient in the copolymerization ingredient, and
the diol component contains diethylene glycol and/or cyclohexane diol in the copolymerizing ingredient.
   (3) A method for manufacturing a two-piece can, comprising the step of multi-stage forming of a circular disk of laminated steel sheet into a final formed body which satisfies the following relations:

0.1≦d/R≦0.25

1.5<h/(R−r)≦4

wherein

h is a height of a final formed body,

r is a maximum radius of the final formed body,

d is a minimum radius of the final formed body (including the case that r and d are equal),

R is a radius of a circular disk, before forming, having the same weight to that of the final formed body,

wherein the laminated steel sheet is used as the laminated steel sheet.
(4) A method for manufacturing a two-piece can, comprising the step of producing the final formed body according to (3), wherein heat treatment is applied as an interim stage of forming so as the formed body is to be heated to a temperature of from 150° C. to the melting point of the polyester resin.
(5) The method for manufacturing a two-piece can according to (4), wherein the heat treatment is carried out two or more times during the forming stage.
(6) The method for manufacturing a two-piece can according to (4), wherein the heat treatment is applied at an interim stage that satisfies the following relations:

0.1≦d/R≦0.25

1.5≦h/(R−r)≦4

wherein

h is a height of the formed body in the interim stage,

r is a maximum radius of the formed body in the interim stage,

d is a minimum radius d of the formed body in the interim stage (including the case that r and d are equal),

R is a radius R of the circular disk, before forming, having the same weight to that of the final formed body.

(7) A two-piece laminated can manufactured by the method according to any of (3) to (6).

### BRIEF DESCRIPTION OF THE DRAWING

FIG. 1 illustrates an example of the manufacturing process of a can.

### DETAILED DESCRIPTION

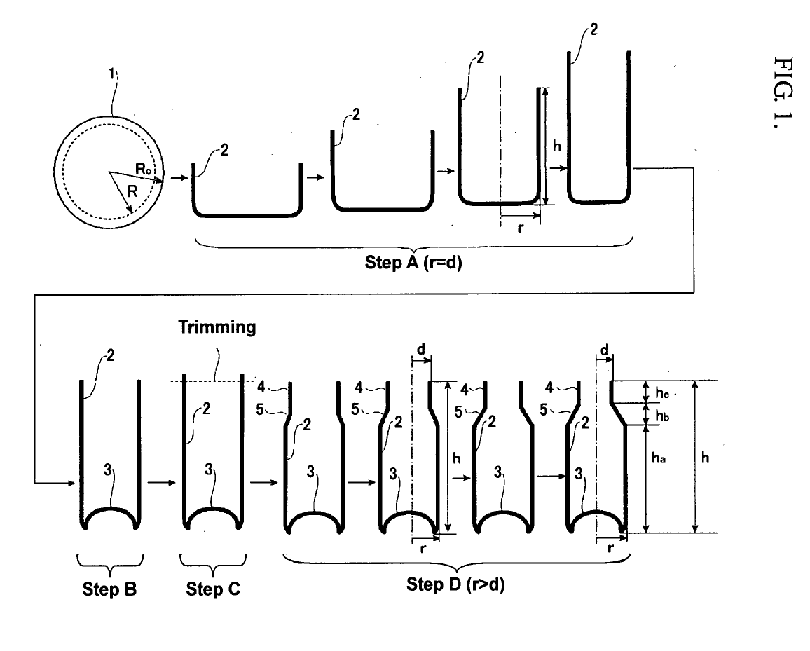

FIG. 1 illustrates an example of the manufacturing process of the can, giving the order of steps of forming a circular blank into a formed body in a shape of a cylinder integrated with the bottom by drawing (including DI forming), and of applying diametral reduction in the vicinity of opening of the formed body, thus obtaining a two-piece can with a diametral reduction part in the vicinity of the opening.

In FIG. 1, reference symbol 1 is the circular disk blank (blank sheet) before forming, 2 is the straight wall part as the base part of the formed body, (in the step D, straight wall part not being worked by diametral reduction), 3 is the dome-shaped part, 4 is the straight wall part at the neck-shaped portion being worked by diametral reduction, and 5 is the taper-shape part, or the tapered wall part after worked by diametral reduction.

First, the circular disk blank 1 is subjected to one or a plurality of steps of drawing (including DI forming) to form a formed body in a shape of a cylinder integrated with a bottom, having a specified can diameter (radius r: radius of outer face of can), (Step A). Then, the bottom part of the formed body is subjected to dome-forming, or to forming into an upward convex shape to form the dome-shaped part 3, (Step B). Further the edge of the opening of the formed body is trimmed, (Step C). Next, the opening of the formed body is subjected to one or a plurality of stages of diametral reduction to bring the opening side of the formed body to a specified can diameter (radius d: radius of the can outer face), thus obtaining the desired final formed body (two-piece can). In FIG. 1, the reference symbol R₀ is the radius of the circular disk blank 1 before forming, and h, r, and d are the height, the maximum radius, and the minimum radius of the formed body during forming or of the final formed body, respectively, and R is the radius of the circular disk, before forming, having equal weight to that of the final formed body. According to the manufacturing process of the two-piece can, Step A results in the maximum radius equal to the minimum radius, or r=d, while Step D results in r>d.

The radius R of the circular disk, before forming, having the same weight as that of the final formed body is determined based on the measured weight of the final formed body. That is, the weight of the final formed body is measured, and the size (radius) of the circular disk, before forming, having the same weight as the measured weight is determined, which determined size is used as the radius R of the circular disk, before forming, having the same weight as that of the final formed body. The can edge portion is trimmed during the can manufacturing process. Since, however, the radius R of the circular disk, before forming, having the same weight as that of the final formed body eliminates the effect of the trimming, a more suitable evaluation of the strain is available.

On the two-piece can which is fabricated by the above drawing (including DI working) and diametral reduction applied to the circular disk blank, the resin layer is elongated in the height direction and compressed in the circumferential direction. When the strain level is high, deformation of the resin becomes large, which leads to fracture of the resin layer. The index of strain level is not only the parameter d/R representing the degree of compression, but also the parameter [h/(R−r)] relating to the elongation in the can height direction because the expression of strain level in a high strain zone needs to consider elongation in addition to the drawing ratio. That is, by specifying the strain level by both the degree of compression and the degree of elongation, the degree of deformation of the resin layer is quantified. By elongation in the height direction and compression in the circumferential direction, the resin layer tends to delaminate, thus, elongation in the height direction becomes an important variable adding to the degree of compression.

The strain level of the final manufactured can (final formed body) is specified such that the relation of the height h of the final formed body, the maximum radius r thereof, the minimum radius d thereof, and the radius R of the circular disk, before forming, has the same weight as that of the final formed body, to satisfy [0.1≦d/R≦0.25] and [1.5≦h/(R−r)≦4].

Using conventional technologies, it has been difficult to manufacture a high strain level of can that satisfies both the parameter d/R specifying the degree of compression not higher than 0.25 and the parameter [h/(R−r)] specifying the degree of elongation not smaller than 1.5 using a laminated steel sheet. Consequently, we specify the strain level d/R of the manufacturing can as 0.25 or less, and [h/(R−r)] as 1.5 or more.

If the strain level is high enough to result in the parameter d/R specifying the degree of compression not higher than 1.0 or the parameter [h/(R−r)] specifying the degree of elongation exceeding 4, the number of forming stages increases even if forming is available, or the sheet elongation reaches its limit by the progress of work hardening, which causes the sheet fracture problem. Therefore, we specify the strain level of manufacturing a can as [0.1≦d/R] and [h/(R−r)≦4].

The multiple stage forming may be any of drawing, drawing-ironing, diametral reduction, and combinations thereof. If the diametral reduction is included in working, the size d of the final formed body is [r>d]. If the diametral reduction is not included, the size of the final formed body is [r=d] (r and d are the radius of final formed body).

We specify the laminated steel sheet with a resin laminate as the metal sheet of base material.

Steel sheet is selected as the base metallic material because steel is less expensive and superior in economy to aluminum. The steel sheet can be ordinary tin-free steel or tinplate. Tin-free steel preferably has a metal chromium layer of about 50 to about 200 mg/m² of surface coating weight and a chromium oxide layer of about 3 to about 30 mg/m² of coating weight as metal chromium. Tinplate preferably has about 0.5 to about 15 g/m² of plating. The sheet thickness is not specifically limited, and that in a range from about 0.15 to about 0.30 mm, for example, is applicable. If no economic consideration is needed, the technology can simply apply also to aluminum base material.

An important characteristic required for the resin layer during the above-described high strain forming is the difficulty in orientation. Resin usually orients in the can height direction owing to compressive deformation in the circumferential direction and to elongational deformation in the can-height direction. Our investigations found promising resins for the high strain forming in view of difficulty in orientation, which resins are prepared by polycondensation of a dicarboxylic acid component with a diol component, wherein the dicarboxylic acid component has terephthalic acid as the main ingredient and contains or does not contain isophthalic acid as another copolymerization ingredient, and the diol component has ethylene glycol and/or butylene glycol as the main ingredient and contains or does not contain diethylene glycol and cyclohexane diol as another copolymerization ingredient. Consequently, we specify the kind of the resin in the resin layer to above resins.

Our investigations, however, also found that, for the polyethylene terephthalate copolymers or polybutylene terephthalate copolymers, the molecules tend to become orientated when the percentage of the copolymerization ingredient is low. That is, a smaller quantity of copolymerization component is likely to generate more cracks (fractures) in parallel with each other in the can-height direction in a zone of high strain level. In concrete terms, it was found that, when the orientation in the resin in the can height direction becomes significant, the bonding force in the circumferential direction becomes weak, which results in fractures in the circumferential direction. The orientation similarly progresses even in the case of applying heat treatment to the can after working. To prevent these problems, the lower limit of the percentage of the copolymerization ingredient is 8% by mole. From the point of difficulty in orientation, a higher percentage of copolymerization ingredient is preferred. However, a percentage above 16% by mole increases the film cost and deteriorates economy. From this point of view, the upper limit of the copolymerization percentage is 16% by mole. Therefore, if cost is not considered, high copolymerization percentage is also suitable.

For the resin layer to follow the deformation accompanying the high strain level, we found that the orientation of laminated steel sheet in the initial stage of working is also an important variable. A film prepared by biaxial orientation or the like is oriented in the plane direction. However, if the film is kept in a high orientation state after lamination, the film cannot follow the working and results in fractures. From this point of view, the plane-orientation factor should be 0.06 or less.

For preparing the laminated steel sheet using a biaxially oriented film with high plane-orientation factor, the temperature during lamination is increased to fully melt the oriented crystals. A film which is prepared by extrusion is suitable because the film is oriented very little. Similarly, the direct lamination method which directly laminates a molten resin on the steel sheet is also suitable because of the same reason.

Upon fabricating the can of high strain level, delamination of laminate may occur depending on the working conditions and the kind of resin. In such a case, it is effective that one or more heat treatments is applied at an interim stage of the multiple stage forming, by heating the formed body to a temperature ranging from 150° C. to the melting point of the polyester resin. Although the heat treatment is performed to relax the internal stress generated by working, relaxation of internal stress affects the recovery of adhesion. That is, the can of high strain level causes large degree of strain in the resin layer, thus likely inducing large internal stress. As a result, the delamination of resin layer may occur with the internal stress as the driving force. Application of adequate heat treatment in a stage of high internal stress before generating delamination, during the forming process, relaxes the internal stress to prevent delamination. The heat treatment, however, has a drawback of progress of orientation to crystallize the resin, thus to deteriorate the formability of the resin layer. In particular, in a zone of high strain level, there may be a need for working after heat treatment. Since working after the heat treatment causes the resin to easily fracture owing to the orientation crystallization, the orientation crystallization is harmful.

From this point of view, we specify the conditions and timing of the heat treatment, adding to the limitation of the kind of resin.

The condition of heat treatment to apply in an interim stage to heat the formed body to a temperature should be in a range from 150° C. to the melting point of the polyester resin. As described above, by selecting a resin that is difficult to orient, orientation crystallization during heat treatment can be suppressed, and the lower limit of the copolymerization percentage is specified.

If the heat treatment temperature exceeds the melting point of the polyester resin, there appear harmful phenomena such as a rough surface layer and adhesion of resin to other material. On the other hand, the lower limit of the heat treatment is takes into account the efficiency of relaxation of the internal stress. That is, although relaxation of internal stress proceeds at a temperature at or above the glass transition point of the polyester resin, excessively low temperatures take a time for relaxation of the stress. Thus, the lower limit of the heat treatment should be 150° C. Therefore, in a manufacturing process which does not care about the treatment time, the treatment temperature of 150° C. or below can be adopted. Generally, however, a long time of treatment deteriorates productivity. Preferable conditions of heat treatment are between 170° C. and [the melting point of polyester resin] −20° C.

The heat treatment in an interim stage which satisfies the relation of the height h of formed body at the interim stage, the maximum radius r thereof, the minimum radius d (including the case that r and d are equal) thereof, with the radius R of the circular disk, before forming, having the same weight to that of the final formed body, is [0.2≦d/R≦0.5] and [1.5≦h/(R−r)≦2.5].

This is because the most effective heat treatment can be provided when the strain level is in that range. That is, the heat treatment in a stage of mild strain level gives only a small effect because relaxation of internal stress is conducted at a stage of not-high internal stress. Heat treatment at a stage of excessively high strain level deteriorates adhesion, thus delamination may occur, which timing is too late. From this point of view, the upper limit and the lower limit of the strain level are specified as above.

The method of heat treatment is not specifically limited, and it was confirmed that electric oven, gas oven, infrared furnace, and induction heater result in similar effects. Heating rate, heating time, and cooling time (the time between the completion of heat treatment and the cooling to the glass transition point of resin) are adequately selected considering the positive effect of relaxing internal stress and the negative effect of orientation crystallization. A higher heating rate is more efficient, and an adequate range of heating time is from about 15 seconds to about 60 seconds. The heating time is, however, not limited to the range. A long cooling time is not preferred in terms of quality because the amount of generated spherulites increases. Consequently, a shorter cooling time is better.

The laminated steel sheet may contain additives such as pigment, lubricant, and stabilizer in the resin layer, and adding to the resin layer a resin layer having other functions may be located at an upper layer or at an intermediate layer above the steel sheet.

Although a thinner resin layer deteriorates formability, the resin layer provides good formability even as a thin layer. The thickness of the resin layer is adequately selected depending on the strain level and other required characteristics. For example, the thickness thereof between 5 to 50 μm is suitably applied. In particular, a thin resin layer of 20 μm or less is a zone of high contribution.

The laminated steel sheet is required to have a laminate of resin layer on at least one side of the steel sheet.

The lamination method for the steel sheet is not specifically limited, and the method is adequately selected such as the heat lamination method which thermally bonds a biaxially oriented film or non-oriented film, and the extrusion method which directly forms a resin layer on the steel sheet using T-die and the like. Both of the methods were confirmed to give sufficient effect.

### EXAMPLE 1

Selected examples are described below.

### [Preparation of Laminated Steel Sheet]

The substrate metal sheet was 0.20 mm thick T4CA, TFS (120 mg/m² of metal Cr layer, 10 mg/m² of chromium oxide layer as metal Cr). Onto the original sheet, various kinds of resin layers were formed using the film-lamination method (heat lamination method) or the direct-lamination method (direct extrusion method). For the film-lamination method, two kinds of the methods were applied, using a biaxially oriented film and a non-oriented film. On both sides of the metal sheet, each film having 20 μm in thickness was laminated.

The plane orientation factor of the laminate film on thus prepared laminated steel sheet was determined by the following procedure.

### [Determination of Plane Orientation Factor]

Abbe's refractometer was used to determine the refractive index under the condition of: light source of sodium/D ray; intermediate liquid of methylene iodide; and temperature of 25° C. The determined refractive indexes were Nx in the machine direction, Ny in the transverse direction, and Nz in the thickness direction of the film. Then, the plane orientation factor Ns was calculated by the following formula:

Plane orientation factor (Ns)=(Nx+Ny)/2−Nz.

TABLE 1 shows the manufacturing method and the characteristics of the laminated steel sheet.

The lamination methods are the following:
Heat lamination method 1: A film prepared by the biaxial orientation method was thermocompressed on a steel sheet which was heated to [the melting point of resin+10° C.] using a nip roll. Then the film was cooled within 7 seconds by water.
Heat lamination method 2: A non-oriented film was thermocompressed on a steel sheet which was heated to [the melting point of resin+10° C.] using a nip roll. Then the film was cooled within 7 seconds by water.
Direct extrusion method: Resin pellets were kneaded and melted in an extruder, which were then extruded through a T-die to laminate onto a running steel sheet. The steel sheet with the resin laminate was nip-cooled on a cooling roll at 80° C., and was further cooled by water.

TABLE 1

| Tested | | | | | | |
|---|---|---|---|---|---|---|
| steel | | Percentage of | | | | |
| sheet | | copolymerization | Melting | | Plane orientation | |
| No. | Kind of resin | ingredient (mol %) | point (° C.) | Lamination method | factor | Remark |
| A1 | PET-I | 8 | 238 | Heat lamination method 1 | 0.02 | Steel sheet of the invention |
| A2 | PET-I | 10 | 233 | Heat lamination method 1 | 0.02 | Steel sheet of the invention |
| A3 | PET-I | 12 | 228 | Heat lamination method 1 | 0.02 | Steel sheet of the invention |
| A4 | PET-I | 14 | 223 | Heat lamination method 1 | 0.02 | Steel sheet of the invention |
| A5 | PET-I | 16 | 218 | Heat lamination method 1 | 0.02 | Steel sheet of the invention |
| A6 | PET-I | 12 | 228 | Heat lamination method 1 | 0.06 | Steel sheet of the invention |
| A7 | PET-I | 12 | 228 | Heat lamination method 1 | 0.04 | Steel sheet of the invention |
| A8 | PET-I | 12 | 228 | Heat lamination method 1 | 0.01 | Steel sheet of the invention |
| A9 | PET-I | 12 | 228 | Heat lamination method 1 | <0.01 | Steel sheet of the invention |
| A10 | PET-I | 12 | 228 | Heat lamination method 2 | <0.01 | Steel sheet of the invention |
| A11 | PET-I | 12 | 228 | Direct extrusion method | <0.01 | Steel sheet of the invention |
| A12 | PET-I | 12 | 202 | Heat lamination method 2 | <0.01 | Steel sheet of the invention |
| A13 | PET-PBT(60)-I | 12 | 211 | Heat lamination method 2 | <0.01 | Steel sheet of the invention |
| A14 | PET-DEG | 12 | 225 | Heat lamination method 2 | <0.01 | Steel sheet of the invention |
| A15 | PET-CHDM | 12 | 224 | Heat lamination method 2 | <0.01 | Steel sheet of the invention |
| A16 | PET-I | 4 | 248 | Heat lamination method 1 | 0.02 | Steel sheet of |
| | | | | | | Comparative Example |
| A17 | PET-I | 2 | 253 | Heat lamination method 1 | 0.02 | Steel sheet of |
| | | | | | | Comparative Example |
| A18 | PET-I | 12 | 228 | Heat lamination method 1 | 0.08 | Steel sheet of |
| | | | | | | Comparative Example |
| A19 | PET | 0 | 258 | Heat lamination method 1 | 0.02 | Steel sheet of |
| | | | | | | Comparative Example |

PET: Polyethylene terephthalate
PET-I: Copolymer of polyethylene terephthalate and isophthalate (isophthalic acid copolymerization percentage: 12 mol %)
PET-PBT(60)-I: Copolymer of polyethylene terephthalate, butylene terephthalate, and isophthalate
(Butylene terephthalate copolymerization percentage: 60 mol %, isophthalic acid copolymerization percentage: 12 mol %)
PET-DEG: Copolymer of terephthalic acid, ethylene glycol, and diethylene glycol
PET-CHDM: Copolymer of terephthalic acid, ethylene glycol, and cyclohexane dimethanol

### [Can Forming]

Using the prepared testing steel sheet, the can (final formed body) was manufactured in accordance with the manufacturing steps shown in FIG. 1, following the procedure described below. TABLE 2 shows the shape of the intermediate formed body (Step C) and the final formed body (Step D). The drawing in Step A was given by five stages, while the diametral reduction in Step D was given by seven stages. The heat treatment was given at a stage between Step A and Step D, heating the can using an infrared heating furnace. After the heat treatment, the can was cooled by water. TABLE 3 shows the timing of heat treatment (strain level of the can when the heat treatment is performed) and the condition of heat treatment.

In TABLE 2, the reference symbols h, r, d, ha, hc, and R of the final formed body (Step D) are the height of the final formed body up to the opening end, the radius of the base part 2, the radius of the neck-shaped part 3, the height of the base part 2, the height of the neck-shaped part 3, and the radius of the circular disk blank, before forming, having the same weight to that of the final formed body, respectively, (refer to FIG. 1). The radius R of the circular disk blank was determined by the following procedure. The weight of the blank sheet before forming and the weight of the final formed body after the step of trimming were measured. Based on thus measured weights, the radius of the blank sheet, before forming, having the same weight to that of the final formed body was determined. Thus determined radius was adopted as the radius R of the circular disk blank, before forming, having the same weight to that of the final formed body.

TABLE 2

| | | Intermediate | | | | | | | | | | |
|---|---|---|---|---|---|---|---|---|---|---|---|---|
| | Blank | formed body | | | | | | | | | | |
| | diameter | (Step C) | | Final formed body (Step D) | | | | | | | | Change rate |
| Can | Rₒ | r | h | r | d | h | ha | hc | Blank diameter | | | of sheet |
| shape | (mm) | (mm) | (mm) | (mm) | (mm) | (mm) | (mm) | (mm) | R* (mm) | d/R | h/(R-r) | thickness** |
| B1 | 41.0 | 11.0 | 63.6 | 11.0 | 7.8 | 65.9 | 47.0 | 9.9 | 40.4 | 0.19 | 2.24 | 1.20 |
| B2 | 47.0 | 11.0 | 63.5 | 11.0 | 7.8 | 65.9 | 47.0 | 9.9 | 46.6 | 0.17 | 1.85 | 1.45 |
| B3 | 35.5 | 11.0 | 63.5 | 11.0 | 7.8 | 65.9 | 47.0 | 9.9 | 34.8 | 0.22 | 2.77 | 0.75 |
| B4 | 33.0 | 11.0 | 63.5 | 11.0 | 7.8 | 65.9 | 47.0 | 9.9 | 32.2 | 0.24 | 3.11 | 0.65 |

*The blank diameter R is derived from conversion of the weight of the final formed body.
**Change rate of sheet thickness = Sheet thickness at the thinnest portion of the can/Thickness of the blank sheet. Both are the steel sheet thickness.

TABLE 3

| | Testing | | | | | | | | | |
|---|---|---|---|---|---|---|---|---|---|---|
| | steel | Melting | | | Condition of heat treatment | | Final | | | |
| Can | sheet | point of | Strain level at heat treatment | | Temperature | Time | can | Film | Film | |
| No. | No. | resin (° C.) | d/R | h/(R-r) | (° C.) | (sec.) | shape | formability | adhesion | Remark |
| C1 | A3 | 228 | 0.38 | 1.78 | 220 | 30 | B1 | ◯ | ⊚ | Example of the invention |
| C2 | A3 | 228 | 0.38 | 1.78 | 220 | 60 | B1 | ◯ | ⊚ | Example of the invention |
| C3 | A3 | 228 | 0.38 | 1.78 | 220 | 90 | B1 | ◯ | ⊚ | Example of the invention |
| C4 | A3 | 228 | 0.38 | 1.78 | 220 | 120 | B1 | ◯ | ⊚ | Example of the invention |
| C5 | A3 | 228 | 0.38 | 1.78 | 228 | 30 | B1 | ◯ | ⊚ | Example of the invention |
| C6 | A3 | 228 | 0.38 | 1.78 | 160 | 80 | B1 | ◯ | ⊚ | Example of the invention |
| C7 | A3 | 228 | 0.38 | 1.78 | 180 | 60 | B1 | ◯ | ⊚ | Example of the invention |
| C8 | A3 | 228 | 0.38 | 1.78 | 200 | 45 | B1 | ◯ | ⊚ | Example of the invention |
| C9 | A3 | 228 | 0.38 | 1.78 | 220 | 30 | B1 | ◯ | ⊚ | Example of the invention |
| C10 | A3 | 228 | 0.30 | 2.10 | 220 | 30 | B1 | ◯ | ⊚ | Example of the invention |
| C11 | A3 | 228 | 0.47 | 1.53 | 220 | 30 | B1 | ◯ | ⊚ | Example of the invention |
| C12 | A3 | 228 | 0.28 | 1.80 | 220 | 30 | B2 | ◯ | ⊚ | Example of the invention |
| C13 | A3 | 228 | 0.31 | 1.70 | 220 | 30 | B2 | ◯ | ⊚ | Example of the invention |
| C14 | A3 | 228 | 0.50 | 2.30 | 220 | 30 | B3 | ◯ | ⊚ | Example of the invention |
| C15 | A3 | 228 | 0.23 | 2.70 | 220 | 30 | B3 | ◯ | ⊚ | Example of the invention |
| C16 | A3 | 228 | 0.55 | 0.20 | 220 | 30 | B3 | ◯ | ◯ | Example of the invention |
| C17 | A3 | 228 | 0.40 | 2.80 | 220 | 30 | B4 | ◯ | ◯ | Example of the invention |
| C18 | A3 | 228 | 0.35 | 2.90 | 220 | 30 | B4 | ◯ | ◯ | Example of the invention |
| C19 | A3 | 228 | 0.23 | 3.05 | 220 | 30 | B4 | ◯ | ◯ | Example of the invention |
| C20 | A3 | 228 | Without heat treatment | | | | B3 | ◯ | ◯ | Example of the invention |
| C21 | A3 | 228 | 0.38 | 1.78 | 220 | 30 | B1 | ◯ | ⊚ | Example of the invention |
| C22 | A3 | 228 | 0.38 | 1.78 | 220 | 30 | B1 | ◯ | ⊚ | Example of the invention |
| C23 | A1 | 238 | 0.38 | 1.78 | 230 | 30 | B1 | ◯ | ⊚ | Example of the invention |
| C24 | A2 | 233 | 0.38 | 1.78 | 230 | 30 | B1 | ◯ | ⊚ | Example of the invention |
| C25 | A4 | 223 | 0.38 | 1.78 | 215 | 30 | B1 | ◯ | ⊚ | Example of the invention |
| C26 | A5 | 218 | 0.38 | 1.78 | 210 | 30 | B1 | ◯ | ⊚ | Example of the invention |
| C27 | A6 | 228 | 0.38 | 1.78 | 220 | 30 | B1 | ◯ | ⊚ | Example of the invention |
| C28 | A7 | 228 | 0.38 | 1.78 | 220 | 30 | B1 | ◯ | ⊚ | Example of the invention |
| C29 | A8 | 228 | 0.38 | 1.78 | 220 | 30 | B1 | ◯ | ⊚ | Example of the invention |
| C30 | A9 | 228 | 0.38 | 1.78 | 220 | 30 | B1 | ◯ | ⊚ | Example of the invention |
| C31 | A10 | 228 | 0.38 | 1.78 | 220 | 30 | B1 | ◯ | ⊚ | Example of the invention |
| C32 | A11 | 228 | 0.38 | 1.78 | 220 | 30 | B1 | ◯ | ⊚ | Example of the invention |
| C33 | A12 | 202 | 0.38 | 1.78 | 220 | 30 | B1 | ◯ | ⊚ | Example of the invention |
| C34 | A13 | 211 | 0.38 | 1.78 | 205 | 30 | B1 | ◯ | ⊚ | Example of the invention |
| C35 | A14 | 225 | 0.38 | 1.78 | 220 | 30 | B1 | ◯ | ⊚ | Example of the invention |
| C36 | A15 | 224 | 0.38 | 1.78 | 220 | 30 | B1 | ◯ | ⊚ | Example of the invention |
| C37 | A16 | 248 | 0.38 | 1.78 | 240 | 30 | B1 | X | ⊚ | Comparative Example |
| C38 | A17 | 253 | 0.38 | 1.78 | 245 | 30 | B1 | X | ⊚ | Comparative Example |
| C39 | A18 | 228 | 0.38 | 1.78 | 220 | 30 | B1 | X | ◯ | Comparative Example |
| C40 | A19 | 258 | 0.38 | 1.78 | 250 | 30 | B1 | X | ⊚ | Comparative Example |

1) Blanking (66 to 94 mmφ)
2) Drawing and ironing (Step A)

Through the five stages of drawing, the cans (intermediate formed bodies) having radius r and height h of the can in a range of r/R from 0.27 to 0.34 and of [h/(R−r)] from 1.84 to 3.09, were manufactured. To manufacture the desired cans, ironing was also applied at need.

3) Forming of dome-shape at can bottom (Step B)

Stretching was applied to the can bottom to a hemispherical shape of 6 mm in depth.

### 4) Trimming (Step C)

The can top edge portion was trimmed by about 2 mm.

5) Diametral reduction at opening portion of the cylinder (Step D)

Diametral reduction was given to the opening portion of the cylinder. In concrete terms, the diametral reduction was conducted by the die-neck method in which the opening end was pressed against a die in an inside-tapered shape, thus manufactured the cans having final can shape given in TABLE 2.

For the cans manufactured by the above procedure, evaluation was given in terms of the adhesion of the film layer to the can, the formability of the film layer, and the appearance of the film layer. The results of the evaluation are also given in TABLE 3.

### [Adhesion Test]

The can was sheared in approximately rectangular shape in the can height direction, having 15 mm of width in the circumferential direction. With thus sheared piece, only the steel sheet was sheared at a position of 10 mm from the bottom in the can height direction, straight in the circumferential direction. As a result, there was prepared a test piece having a 10 mm portion in the can height direction toward the can bottom and a residual portion with the boundary of the sheared position. At the 10 mm portion, a steel sheet having 15 mm in width and 60 mm in length was joined (welded). Then, the 60 mm steel sheet portion was clamped to forcefully separate the film on the residual portion by about 10 mm from the sheared position. The peeling test was conducted in 180° direction with the clamping areas of the film-separated portion and the 60 mm steel sheet portion. The minimum peeling strength among the observed values was adopted as the index of adhesion.

### [Peeling Strength]

Less than 4N/15 mm: X
4N/15 mm or more and less than 6N/15mm: ∘
6N/15 mm or more: ∘

### [Evaluation of Film Formability]

The outer surface of the resin layer after the can forming was observed visually and with a light microscope to confirm the presence/absence of fracture of film. The resin layer giving normal appearance was evaluated as ∘, and the resin layer showing fracture and crack was evaluated as X.

### [Results of Evaluation]

Cans C1 to C15 and C21 to C36 are Examples, and were subjected to heat treatment within our range. They showed good film formability and adhesion.

Cans C16 to C20 are Examples. However, they were not subjected to a preferred heat treatment, or they were subjected to the heat treatment outside the preferred timing. As a result, they gave only ∘ evaluation for the adhesion, though both the film formability and the adhesion passed the evaluation.

Cans C37, C38, and C40 are Comparative Examples. The evaluation of formability was X because the copolymerization percentage of isophthalic acid was outside our range.

Can C39 is an example having a plane orientation factor outside our range, and the formability was evaluated to X.

1. A laminated steel sheet used for producing two-piece can, which satisfies the following relations:
0.1≦d/R≦0.25
1.5≦h/(R−r)≦4
wherein
h is a height of a final formed body,
r is a maximum radius of the final formed body,
d is a minimum radius of the final formed body (including when r and d are equal),
R is a radius of a circular disk, before forming, having the same weight as that of the final formed body,
wherein
at least one face of the steel sheet has a polyester resin layer,
the polyester resin is obtained by polycondensation of a dicarboxylic acid component and a diol component,
the dicarboxylic component contains terephthalic acid as the main ingredient and a copolymerizing ingredient,
the diol component comprises ethylene glycol and/or butylene glycol as a main ingredient and a copolymerizing ingredient, the sum of the copolymerizing ingredient in the dicarboxylic acid and the copolymerizing ingredient in the diol component ranges from 8 to 16% by mole in the polyester resin, and
the polyester resin laminate layer has 0.06 or less of plane orientation factor.

2. The laminated steel sheet according to claim 1, wherein
the dicarboxylic acid component comprises an isophthalic acid ingredient in the copolymerization ingredient, and
the diol component comprises diethylene glycol and/or cyclohexane diol in the copolymerizing ingredient.

3. A method for manufacturing a two-piece can comprising multi-stage forming a circular disk of the laminated steel sheet according to claim 1 into a final formed body which satisfies the following relations:
0.1≦d/R≦0.25
1.5≦h/(R−r)≦4
wherein
h is a height of a final formed body,
r is a maximum radius of the final formed body,
d is a minimum radius of the final formed body (including when r and d are equal),
R is a radius of a circular disk, before forming, having the same weight as that of the final formed body.

4. A method for manufacturing a two-piece can comprising producing the final formed body according to claim 3, wherein heat treatment is applied as an interim stage of forming so that the formed body is heated to a temperature of from 150° C. to the melting point of the polyester resin.

5. The method according to claim 4, wherein the heat treatment is carried out two or more times during forming.

6. The method according to claim 4, wherein the heat treatment is applied at an interim stage that satisfies the following relations:
0.1≦d/R≦0.25
1.5≦h/(R−r)≦4
wherein
h is a height of the formed body in the interim stage,
r is a maximum radius of the formed body in the interim stage,
d is a minimum radius d of the formed body in the interim stage (including when r and d are equal),
R is a radius R of the circular disk, before forming, having the same weight as that of the final formed body.

7. A two-piece laminated can manufactured by the method according to claim 3.

8. A two-piece laminated can manufactured by the method according to claim 4.

9. A two-piece laminated can manufactured by the method according to claim 5.

10. A two-piece laminated can manufactured by the method according to claim 6.
